(19) United States
(12) Patent Application Publication
(10) Pub. No.: US 2020/0094440 A1
(43) Pub. Date: Mar. 26, 2020

(54) COMPOSITION FOR LOW SPECIFIC GRAVITY MOLDED FOAM AND METHOD FOR PRODUCING MOLDED FOAM USING THE COMPOSITION

(71) Applicant: Fine Chemical Co., Ltd., Gimhae-si (KR)

(72) Inventor: Sung Yull LEE, Busan (KR)

(21) Appl. No.: 16/616,887

(22) PCT Filed: Feb. 12, 2019
(86) PCT No.: PCT/KR2019/001678

§ 371 Date: Nov. 25, 2019

(30) Foreign Application Priority Data
Feb. 13, 2018 (KR) 10-2018-0017663

(51) Int. Cl. B29B 9/12; C08L 23/08; C08L 23/06; C08L 23/16; C08L 9/00; C08J 9/10; C08J 9/232; C08J 9/00; B29C 44/34; B29C 44/02

(52) U.S. Cl. CPC B29B 9/12; B29K 2023/083; C08L 23/06; C08L 23/16; C08L 9/00; C08J 9/103; C08J 9/232; C08J 9/0061; B29C 44/3461; B29C 44/02; B29C 44/3415; C08L 2203/16; C08L 2205/03; C08L 2205/025; C08L 2205/20; C08L 2207/066; C08L 2207/062; C08L 2312/00; C08J 2201/03; C08J 2203/04; C08J 2203/22; C08J 2323/08; C08J 2323/06; C08J 2323/16; C08J 2309/00; C08L 23/0853

(57) ABSTRACT

Provided is a composition for a low specific gravity molded foam. The composition includes at least one polymer component selected from the group consisting of a peroxide-crosslinkable thermoplastic resin, a peroxide-crosslinkable rubber and a peroxide-crosslinkable thermoplastic elastomer, thermally expandable microspheres, and an organic peroxide crosslinking agent.

### TECHNICAL FIELD

The present disclosure relates to a composition for a low specific gravity molded foam and a method for producing a molded foam using the composition. More specifically, the present disclosure relates to a composition for a low specific gravity molded foam with no shrinkage and good durability and a method for producing a molded foam using the composition.

### BACKGROUND ART

Generally, molded foams made of plastic materials are produced by the following methods.

According to the first method, a blowing agent-containing plastic material is fed into a hopper of a plastic molding machine and is simply injection molded in a cold mold or injection molded while the volume of a mold cavity is increasing at a constant rate.

According to the second method, a plastic material is fed into a hopper of a plastic molding machine in which a gas injection hole is formed at a predetermined portion of a cylinder, and is injection molded in a cold mold while supercritical CO₂ gas is introduced into the cylinder through the gas injection hole.

According to the third method, a liquid resin is mixed with a blowing agent in a high speed mixer to make a foam such as a polyurethane foam, and then the foam is loaded into a mold and cured at high or room temperature to produce a molded foam.

According to the fourth method, a molded foam is produced using a bead foam material such as expanded polystyrene (EPS), expanded polypropylene (EPP) or expanded polylactic acid (EPLA). Specifically, a resin is extruded into 0.5-0.8 mm diameter mini-pellets (also called “beads”), the mini-pellets are loaded into a high pressure tank filled with a predetermined amount of an inert gas, a high pressure is applied to allow the inert gas to penetrate the mini-pellets. Then, the pellets are expanded with steam in a pre-expander to produce prefoamed pellets having a specific gravity as low as 0.02-0.06, the prefoamed pellets are introduced into a steam chest mold of a molding machine, steam and air pressure are simultaneously applied to melt the surface of the prefoamed pellets such that the pellets adhere together and fill the mold cavity. Then, the steam and air are eliminated, cooling air is introduced to cool the product, and the final product is demolded.

According to the fifth method, a peroxide crosslinking agent and a chemical blowing agent are mixed with an ethylene copolymer such as EVA for the production of EVA foams for shoes, the mixture is filled in a mold and heated to a predetermined temperature under pressure for a predetermined time, the mold is opened to release a foamed product whose size is 3-5 times larger than the internal volume of the mold, and the foamed product is cooled to obtain a molded foam.

However, the first method achieves only a limited degree of foaming (10-20%) and fails to provide a sufficient degree of foaming. Another problem of the first method is that the internal cell structure is not regular, resulting in non-uniform physical properties. For these reasons, the first method is not currently in use.

The second method ensures a uniform cell structure and an attractive appearance of a foamed product, but is inefficient in increasing the foaming magnification. Thus, the second method is not suitable for manufacturing products having a density of 0.5 g/cc or less and is only applicable to limited products.

The third method facilitates the manufacture of products with uniform physical properties. However, poor weather resistance of products manufactured by the third method makes the use of the products in outdoor environments impossible. Further, the products suffer from rapid deterioration of physical properties in the presence of moisture due to their poor hydrolytic stability. The products have open cells rather than closed cells. Due to this structure, the products have low compressive strength and their high hardness is thus difficult to achieve.

In the fourth method, EPS as a bead foam material is used in various applications such as packaging due to its low price and ease of production. However, EPS is prone to fracture during handling because of its brittleness, causing environmental pollution. Particularly, when used for floats for oyster farming, EPS is broken into pieces by sunlight and wave action, causing severe pollution of the sea and the surrounding coast. EPP is used as a shock absorbing material in various applications such as automobile bumpers and motorcycle helmets, but is difficult to mold and handle and is expensive. EPP is not applicable to the manufacture of soft elastic products but is applicable to the manufacture of high hardness products. Expanded polystyrene (EPS) in the form of beads has a good ability to capture an internal gas. Due to this ability, expanded polystyrene is supplied in the form of beads to steam chest molding companies where the supplied expanded polystyrene is pre-expanded before use. In contrast, EPP in the form of beads has a poor ability to capture an internal gas. Accordingly, EPP suppliers pre-expand the as-produced EPP and supply the pre-expanded EPP in the form of low specific gravity prefoams to steam chest molding companies, resulting in an increase in the transportation cost of the raw material compared to that of EPS. The bead foams have many risk factors such as handling of high-pressure gas. Thus, most large factories supply large quantities of beads but small and medium-sized companies suffer from difficulties in manufacturing products with different physical properties from various materials because they are unable to directly handle and use the materials. Since the highest accessible temperature with steam does not exceed a maximum of 150° C. on account of the characteristics of steam chest molding, general polypropylene cannot be used and only random copolymers having a melting point of 150° C. or less can be used, making it impossible to manufacture high hardness products. Further, the use of random copolymers only necessitates a long time for sufficiently melting the surface of prefoams upon steam chest molding, leading to an increase in manufacturing cost. A reduction in melding time leads to insufficient melting, causing many problems such as low strength of molded foams.

The fifth method has the advantages of low production cost and ease of production. However, a high degree of crosslinking makes the foaming difficult and a low degree of crosslinking cannot ensure good heat resistance of the molded foam. Further, the volume of the final product after demolding is 3-5 times larger than the internal volume of the mold, causing a large deviation in the size of the final molded product. Since the raw material expands after being crosslinked to some extent, it may shrink after expansion, making it difficult to manage the dimensions of the product. This method is not suitable for manufacturing products with large volume and thickness. The reason is because a portion of the product corresponding to the parting line of the mold is over-cured when it is desired to crosslink the internal portion of the product. This over-curing causes tearing of the product. Optimum curing of the portion of the product corresponding to the parting line causes under-curing of the inner portion of the product, deteriorating the physical properties of the product, and increases the shrinkage of the product immediately after molding, making it difficult to manufacture the product.

### DETAILED DESCRIPTION OF THE INVENTION

### Means for Solving the Problems

According to one aspect of the present disclosure, there is provided a composition for a low specific gravity molded foam, including at least one polymer component selected from the group consisting of a peroxide-crosslinkable thermoplastic resin, a peroxide-crosslinkable rubber and a peroxide-crosslinkable thermoplastic elastomer, thermally expandable microspheres, and an organic peroxide crosslinking agent.

According to a further aspect of the present disclosure, there is provided a method for producing a low specific gravity molded foam, including: providing a foamable composition including a mixture of at least one polymer component selected from the group consisting of a peroxide-crosslinkable thermoplastic resin, a peroxide-crosslinkable rubber and a peroxide-crosslinkable thermoplastic elastomer, thermally expandable microspheres, and an organic peroxide crosslinking agent; introducing the foamable composition into a mold for producing a molded foam; raising the temperature of the foamable composition to at least the expansion start temperature (Tstar) of the thermally expandable microspheres to expand the foamable composition in the mold; forming a molded foam in a state in which the foamable composition is expanded to fill the mold; and releasing the molded foam from the mold.

According to another aspect of the present disclosure, there is provided a low specific gravity molded foam having a specific gravity of 0.5 or less produced by the method.

### BRIEF DESCRIPTION OF THE DRAWINGS

FIG. 1 is a flowchart illustrating one embodiment of a method for producing a low specific gravity molded foam.

### MODE FOR CARRYING OUT THE INVENTION

The present disclosure will now be described in more detail.

As described above, a need exists to develop a composition for a low specific gravity molded foam that can overcome the limitations of conventional low specific gravity molded foams, uses a rubber or thermoplastic elastomer as a raw material, undergoes no shrinkage, is unlikely to be defective, has good heat resistance, wear resistance, and slip resistance, and is not hydrolyzed. In addition, there is a need to develop a method for producing a molded foam using the composition.

One aspect of the present disclosure provides a composition for a low specific gravity molded foam. The composition includes at least one polymer component selected from the group consisting of a peroxide-crosslinkable thermoplastic resin, a peroxide-crosslinkable rubber and a peroxide-crosslinkable thermoplastic elastomer, thermally expandable microspheres, and an organic peroxide crosslinking agent.

Thermoplastic resins can be divided into peroxide-crosslinkable thermoplastic resins and non-peroxide-crosslinkable thermoplastic resins. Examples of the non-peroxide-crosslinkable thermoplastic resins include propylene homopolymers, propylene copolymers, polybutene-1, polyvinyl chloride homopolymers, polyvinyl chloride copolymers, polystyrene, styrene acrylonitrile (SAN) copolymers, acrylonitrile butadiene styrene (ABS) copolymers, polyamide, polyacetal, polycarbonate, polyester, polyphenylene oxide and the like.

According to one embodiment of the present disclosure, the peroxide-crosslinkable thermoplastic resin used in the composition of the present disclosure may be selected from the group consisting of an ethylene homopolymer, an ethylene copolymer, a chlorinated polyethylene resin, and mixtures thereof.

The ethylene homopolymer may be any one selected from the group consisting of low density polyethylene (LDPE), linear low density polyethylene (LLDPE), ultra-low density polyethylene (ULDPE), very low density polyethylene (VLDPE), medium density polyethylene (MDPE), and high density polyethylene (HDPE).

The ethylene copolymer may be a copolymer of i) ethylene and ii) at least one ethylenically unsaturated monomer selected from the group consisting of C₃-C₁₀ α-olefins, C₁-C₁₂ alkyl esters of unsaturated C₃-C₂₀ monocarboxylic acids, unsaturated C₃-C₂₀ mono- or dicarboxylic acids, anhydrides of unsaturated C₄-C₈ dicarboxylic acids, and vinyl esters of saturated C₂-C₁₈ carboxylic acids or an ionomer of the copolymer.

Preferably, ethylene makes up the largest mole fraction of the ethylene copolymer. Typically, ethylene accounts for about 50 mole % or more of the polymer. More preferably, ethylene accounts for about 60 mole % or more, about 70 mole % or more or about 80 mole % or more of the polymer.

Specific examples of such ethylene copolymers include ethylene vinyl acetate (EVA) copolymers, ethylene butyl acrylate (EBA) copolymers, ethylene methyl acrylate (EMA) copolymers, ethylene ethyl acrylate (EEA) copolymers, ethylene methyl methacrylate (EMMA) copolymers, ethylene butene copolymers (EB-Co), and ethylene octene copolymers (EO-Co).

The ethylene copolymer is preferably a copolymer of ethylene and an α-olefin, which is preferred in terms of high elasticity. The α-olefin refers to an olefin consisting of at least three carbon atoms and having a terminal carbon-carbon double bond. The substantial remainder of the ethylene/α-olefin copolymer except for ethylene includes one or more other comonomers. The comonomers are preferably α-olefins having three or more carbon atoms. The α-olefin is preferably butene, hexene or octene in terms of commercial availability and ease of purchase. For example, the ethylene/α-olefin copolymer may be an ethylene/octene copolymer. In this case, the copolymer includes about 80 mole % or more of ethylene and about 10 to about 15 mole %, preferably about 15 to about 20 mole % of octene.

The ethylene/α-olefin copolymer may be a random or block copolymer and specific examples thereof include polyolefin elastomers (POEs) and olefin block copolymers (OBCs). Commercial products for the ethylene/α-olefin copolymer include Engage and Infuse from Dow Chemical, Tafmer from Mitsui, Exact from Exxon Mobile, and LG-POE from LG Chem.

The chlorinated polyethylene resin may be selected from the group consisting of a chlorinated polyethylene homopolymer, a chlorinated copolymer containing i) ethylene and ii) a copolymerizable monomer as copolymerization units, and mixtures thereof.

Specific examples of such chlorinated polyethylene homopolymers include chlorinated high density polyethylene homopolymers, chlorinated low density polyethylene homopolymers, and chlorinated ultra-high density polyethylene homopolymers.

The chlorinated copolymer may be one of i) ethylene and ii) at least one ethylenically unsaturated monomer selected from the group consisting of C₃-C₁₀ α-monoolefins, C₁-C₁₂ alkyl esters of unsaturated C₃-C₂₀ monocarboxylic acids, unsaturated C₃-C₂₀ mono- or dicarboxylic acids, anhydrides of unsaturated C₄-C₈ dicarboxylic acids, and vinyl esters of saturated C₂-C₁₈ carboxylic acids. Examples of such chlorinated copolymers include chlorinated graft copolymers.

Specific examples of suitable chlorinated copolymers include chlorinated ethylene vinyl acetate copolymers, chlorinated ethylene acrylic acid copolymers, chlorinated ethylene methacrylic acid copolymers, chlorinated ethylene methyl acrylate copolymers, chlorinated ethylene methyl methacrylate copolymers, chlorinated ethylene butyl acrylate copolymers, chlorinated ethylene butyl methacrylate copolymers, chlorinated ethylene glycidyl methacrylate copolymers, chlorinated graft copolymers of ethylene and maleic anhydride, and chlorinated copolymers of propylene, butene, 3-methyl-1-pentene or octene and ethylene. Here, the copolymers may be binary copolymers, ternary copolymers or higher order copolymers.

Preferably, the chlorinated polyethylene resin is selected from a chlorinated polyethylene homopolymer, a chlorinated ethylene vinyl acetate copolymer, a chlorinated ethylene butyl acrylate copolymer, a chlorinated ethylene methyl acrylate copolymer, a chlorinated ethylene methyl methacrylate copolymer, a chlorinated ethylene butene copolymer, and a chlorinated ethylene octene copolymer.

The content of chlorine in the chlorinated polyethylene resin may be 30 to 70% by weight, preferably 30 to 50% by weight, based on the total weight of the chlorinated polyethylene resin. If the chlorine content is less than the lower limit defined above, the structure of the chlorinated polyethylene resin becomes similar to that of polyethylene. In this case, the chlorinated polyethylene resin has insufficient rebound resilience and high stiffness, and as a result, it is not suitable for use in the production of a desired foam for outdoor applications. Meanwhile, if the chlorine content exceeds the upper limit defined above, the chlorinated polyethylene resin has excessively high hardness and tends to be brittle, and as a result, it is difficult to process and foam, making the production of a foam impossible.

The peroxide-crosslinkable thermoplastic resin used in the composition of the present disclosure can be prepared in the presence of a Ziegler-Natta catalyst, a metallocene- or vanadium-based coordination catalyst or a free-radical initiator. The low density polyethylene (LDPE) may have a density of about 0.910 g/cm³ to about 0.930 g/cm³, as measured by ASTM D-792. The linear low density polyethylene (LLDPE) may have a density of about 0.850 g/cm³ to about 0.940 g/cm³ and a melt index of about 0.01 g/10 minutes to about 100 g/10 minutes, as measured by ASTM 1238, Condition I. The melt index of the linear low density polyethylene (LLDPE) is preferably about 0.1 g/10 minutes to about 50 g/10 minutes. The LLDPE is preferably a copolymer of ethylene and one or more other C₃-C₁₈ α-olefins, more preferably C₃-C₈ α-olefins. Preferred comonomers include 1-butene, 4-methyl-1-pentene, 1-hexene, and 1-octene. The ultra-low density polyethylene (ULDPE) and the very low density polyethylene (VLDPE) may have a density of about 0.860 g/cm³ to about 0.910 g/cm³. The medium density polyethylene (MDPE) is typically a homopolymer having a density of about 0.926 g/cm³ to about 0.940 g/cm³. The high density polyethylene (HDPE) is typically a homopolymer having a density of about 0.941 g/cm³ to about 0.965 g/cm³.

The peroxide-crosslinkable thermoplastic resin used in the composition of the present disclosure has 0.01 to 20 side chains larger than CH₃, preferably C₂-C₆ side chain branches per 1000 carbon atoms. The number of side chains larger than CH₃, preferably C₂-C₆ side chain branches in the peroxide-crosslinkable thermoplastic resin is preferably 1 to 15 per 1000 carbon atoms. The number of side chains larger than CH₃, preferably C₂-C₆ side chain branches in the peroxide-crosslinkable thermoplastic resin is particularly preferably 2 to 8 per 1000 carbon atoms. The number of side chain branches larger than CH₃ per 1000 carbon atoms is determined by ¹³C-NMR and indicates the total content of side chains larger than CH₃ per 1000 carbon atoms (the end groups are excluded).

The molecular weight distribution (M_{w}/Mₙ) of the peroxide-crosslinkable thermoplastic resin suitable for use in the composition of the present disclosure is in the range of 6 to 100, preferably 11 to 60, particularly preferably 20 to 40. The density of the peroxide-crosslinkable thermoplastic resin suitable for use in the composition of the present disclosure is in the range of 0.89 to 0.98 g/cm³, preferably 0.90 to 0.97 g/cm³. The weight average molecular weight (M_{w}) of the peroxide-crosslinkable thermoplastic resin suitable for use in the composition of the present disclosure is in the range of 5,000 to 700,000 g/mol, preferably 30,000 to 550,000 g/mol, particularly preferably 70,000 g/mol to 450,000 g/mol. Within the molecular weight, molecular weight distribution, and density ranges, a molded foam with good processability and excellent mechanical properties can be produced.

The melt index (MI) of the peroxide-crosslinkable thermoplastic resin is in the range of 1.0 to 50 g/10 minutes, preferably 1.0 to 30 g/10 minutes, more preferably 2.0 to 25 g/10 minutes, as measured by ASTM D1238 (190° C., 2.16 kg). The melt index of the peroxide-crosslinkable thermoplastic resin is particularly preferably in the range of 2.0 to 20 g/10 minutes. When a peroxide-crosslinkable thermoplastic resin is melt-kneaded using suitable equipment such as an extruder, a higher melt index of the thermoplastic resin leads to a lower load of the equipment. If the melt index of the peroxide-crosslinkable thermoplastic resin is lower than the lower limit defined above, too high a pressure is applied to a processing machine, causing a severe load in the machine. Further, a very small amount of the composition is extruded per unit time, which is economically disadvantageous. Meanwhile, if the melt index of the peroxide-crosslinkable thermoplastic resin exceeds the upper limit defined above, the viscosity of the composition is low, resulting in an excessively high tackiness of the mixture immediately after passing through an extrusion die. In this case, the extrudate is not readily cut, making it difficult to pelletize the extrudate in the subsequent step. The resin composition may optionally further include one or more additives. Also in this case, it is preferable to control the melt index of the resin composition to the range defined above for the same reason.

Rubbers can be divided into peroxide-crosslinkable rubbers and non-peroxide-crosslinkable rubbers. Examples of the non-peroxide-crosslinkable rubbers include chloroprene rubber (CR), butyl rubber (IIR), acrylic rubber, and fluorinated rubber.

According to one embodiment, the peroxide-crosslinkable rubber used in the composition of the present disclosure may be selected from the group consisting of natural rubber (NR), isoprene rubber (IR), styrene butadiene rubber (SBR rubber), butadiene rubber (BR), nitrile butadiene rubber (NBR), hydrogenated nitrile butadiene rubber (HNBR), ethylene propylene diene monomer (EPDM) rubber, chlorosulphonated polyethylene rubber, silicone rubber, and mixtures thereof.

Thermoplastic elastomers can be divided into peroxide-crosslinkable thermoplastic elastomers and non-peroxide-crosslinkable thermoplastic elastomers. Examples of the non-peroxide-crosslinkable thermoplastic elastomers include thermoplastic polyurethane (TPU) elastomers, thermoplastic polyester elastomers (TPEEs), and thermoplastic polyamide elastomers (TPAEs).

According to one embodiment, the peroxide-crosslinkable thermoplastic elastomer used in the composition of the present disclosure may be selected from the group consisting of styrene block copolymers, including styrene-butadiene-styrene (SBS) block copolymers, styrene-isoprene-styrene (SIS) block copolymers, styrene-ethylene-butadiene-styrene (SEBS) block copolymers, styrene-butylene-butadiene-styrene (SBBS) block copolymers, and styrene-ethylene-propylene-styrene (SEPS) block copolymers, 1,2-polybutadiene (1,2-PB), thermoplastic polyolefin (TPO), and mixtures thereof.

The thermally expandable microspheres used in the composition of the present disclosure are polymer particles that encapsulate an expandable hydrocarbon compound therein. The expandable hydrocarbon compound is generally in the form of a powder but is volatilized or thermally decomposed to generate a gas above a predetermined temperature, forming pores in the thermally expandable microspheres. The polymer expands to form shells. The polymer is not broken due to its high softness and elasticity. If the thermally expandable microspheres rupture during expansion due to overheating, a gas escapes from the thermally expandable microspheres during molding of the composition and is finally lost, with the result that little or no expansion occurs. Excellent surface characteristics can be attained when the polymer is not broken.

The thermally expandable microspheres are expanded by heating during molding of the composition. An expanded molded product obtained from the composition including the thermally expandable microspheres can be formed as a foamed body.

Preferably, the boiling point of the expandable hydrocarbon compound is not higher than the softening temperature of the shells, for example, about 100° C. or less, at which the shell-forming polymer is not dissolved in the expandable hydrocarbon compound. A liquid material with low boiling point, also called a volatile blowing agent, is usually used as the expandable hydrocarbon compound. Alternatively, a solid material capable of generating a gas when thermally decomposed may be used as the expandable hydrocarbon compound.

Examples of suitable liquid materials include C₃-C₈ straight-chain aliphatic hydrocarbons and their fluorinated products, C₃-C₈ branched aliphatic hydrocarbons and their fluorinated products, C₃-C₈ alicyclic hydrocarbons and their fluorinated products, ether compounds having C₂-C₈ hydrocarbon groups, or the ether compounds in which some hydrogen atoms of the hydrocarbon groups are substituted with fluorine atoms. Specific examples of such liquid materials include propane, cyclopropane, butane, cyclobutane, isobutane, pentane, cyclopentane, neopentane, isopentane, hexane, cyclohexane, 2-methylpentane, 2,2-dimethylbutane, heptane, cycloheptane, octane, cyclooctane, methylheptanes, trimethylpentane, 1-pentene, 1-hexene, and hydrofluoroethers such as C₃F₇OCH₃, C₄F₉OCH₃ and C₄F₉OC₂H₅. These liquid materials may be used alone or as a mixture of two or more thereof. The liquid material is preferably a hydrocarbon having a boiling point lower than 60° C. at atmospheric pressure. Isobutane is preferred as the liquid material in the hollow microspheres. The solid material may be azobisisobutyronitrile (AIBN) that is thermally decomposed into a gas.

The content of the expandable hydrocarbon compound encapsulated in the thermally expandable microspheres is not particularly limited and may vary depending on the intended use. For example, the content of the encapsulated expandable hydrocarbon compound may be about 0.5 to about 15% by weight, preferably about 1 to about 10% by weight, based on the total weight of the thermally expandable microspheres. The thermally expandable microspheres may generally be prepared by mechanically dispersing a mixture containing a polymerizable monomer, a blowing agent and the like in an incompatible liquid such as water, followed by suspension polymerization of the monomer droplets.

The thermally expandable microspheres used in the composition may have an average particle diameter in the range of about 5 to about 60 m, for example, about 10 to about 50 m or about 20 to about 35 m, before expansion. Within this range, the thermally expandable microspheres form shells having an appropriate thickness without rupture during expansion and their thermal expansion behavior can be promoted. The expansion start temperature (Tₛₜₐᵣₜ) and maximum expansion temperature (Tₘₐₓ) of the thermally expandable microspheres can be determined depending on the boiling point of the expandable hydrocarbon compound and the glass transition temperature (T_{g}) of the shell-forming polymer.

The polymer capable of forming a shell, i.e., the shell-forming polymer upon expansion may basically be any thermoplastic resin that can be softened to expand the gas therein at the expansion start temperature. Specifically, the shell-forming polymer may be an acrylic resin, a vinylidene chloride resin, an acrylonitrile resin, an ABS resin, polyethylene, polyethylene terephthalate, polypropylene, polystyrene, a vinyl chloride resin, an acetal resin, a cellulose ester, cellulose acetate, a fluorinated resin, polymethylpentene or a mixture thereof but is not limited thereto. The shell-forming polymer may be, for example, a polymer or copolymer including at least one monomer selected from the group consisting of, but not limited to, acrylonitrile, methacrylonitrile, methyl methacrylate, methyl acrylate, ethyl acrylate, propyl acrylate, n-butyl acrylate, isobutyl acrylate, t-butyl acrylate, 2-ethylhexyl acrylate, n-octyl acrylate, lauryl acrylate, stearyl acrylate, 2-hydroxyethyl acrylate, polyethylene glycol acrylate, methoxypolyethylene glycol acrylate, glycidyl acrylate, dimethylaminoethyl acrylate, diethylaminoethyl acrylate, vinylidene chloride, butadiene, styrene, p- or m-methylstyrene, p- or m-ethylstyrene, p- or m-chlorostyrene, p- or m-chloromethylstyrene, styrene sulfonic acid, p- or m-t-butoxystyrene, vinyl acetate, vinyl propionate, vinyl butyrate, vinyl ether, allyl butyl ether, allyl glycidyl ether, unsaturated carboxylic acids, including (meth)acrylic acid or maleic acid, and alkyl (meth)acrylamides. The polymer can be suitably selected according to the intended purpose such as its softening temperature, heat resistance, and chemical resistance. For example, the polymer may be a copolymer including vinylidene chloride that has excellent gas barrier properties. Alternatively, the polymer may be a copolymer including at least about 80% by weight of a nitrile monomer that is excellent in heat resistance and chemical resistance. The shells of the thermally expandable microspheres are composed of an acrylic copolymer (i.e. an acrylonitrile copolymer) of a nitrile monomer and a (meth)acrylate monomer as major components, which is preferable for heat resistance of the composition of the present disclosure.

The composition may include 1 part by weight to 20 parts by weight, preferably 3 parts by weight to 15 parts by weight of the thermally expandable microspheres, based on 100 parts by weight of the polymer component such as the peroxide-crosslinkable thermoplastic resin, rubber or thermoplastic elastomer. If the content of the thermally expandable microspheres is less than the lower limit defined above, sufficient foaming cannot be achieved. Meanwhile, if the content of the thermally expandable microspheres exceeds the upper limit defined above, excessive foaming may occur, and as a result, the strength of a final molded foam may be lowered, causing problems in use.

The composition may further include one or more additives selected from the group consisting of metal oxides and antioxidants that are commonly used for the production of a foamed body to assist in improving the processing properties and to improve the physical properties of the foamed body.

The additives may be used in an amount of 0.01 to 5 parts by weight, based on 100 parts by weight of the polymer component. The metal oxide can be used to improve the physical properties of a foamed body and examples thereof include zinc oxide, titanium oxide, cadmium oxide, magnesium oxide, mercury oxide, tin oxide, lead oxide, and calcium oxide. The metal oxide may be used in an amount of 1 to 4 parts by weight, based on 100 parts by weight of the polymer component. Examples of the antioxidants include Sonnoc, butylated hydroxy toluene (BHT), and Songnox 1076 (octadecyl-3,5-di-tert-butyl hydroxyhydrocinnamate). The antioxidant may be used in an amount of 0.25 to 2 parts by weight, based on 100 parts by weight of the polymer component.

Early crosslinking of the composition prevents foaming of the polymer component. For efficient foaming of the polymer component, it is preferable that the expansion start temperature (Tstar) of the thermally expandable microspheres is equal to or lower than the 1 minute half-life temperature of the organic peroxide crosslinking agent.

The organic peroxide crosslinking agent has a 1 minute half-life temperature of 130 to 180° C. Specific examples of such organic peroxide crosslinking agents include t-butylperoxyisopropyl carbonate, t-butyl peroxylaurylate, t-butyl peroxyacetate, di-t-butyl peroxyphthalate, t-dibutyl peroxy maleic acid, cyclohexanone peroxide, t-butylcumyl peroxide, t-butyl hydroperoxide, t-butyl peroxybenzoate, dicumyl peroxide, 1,3-bis(t-butylperoxyisopropyl)benzene, methyl ethyl ketone peroxide, 2,5-dimethyl-2,5-di(benzoyloxy)hexane, 2,5-dimethyl-2,5-di(t-butylperoxy)hexane, di-t-butyl peroxide, 2,5-dimethyl-2,5-(t-butylperoxy)-3-hexane, n-butyl-4,4-bis(t-butylperoxy)valerate, and α,α′-bis(t-butylperoxy)diisopropylbenzene.

According to one embodiment, the composition of the present disclosure may include 0.02 to 4 parts by weight, preferably 0.02 to 3 parts by weight, more preferably 0.05 to 1.5 parts by weight of the organic peroxide crosslinking agent, based on 100 parts by weight of the polymer component. If the organic peroxide crosslinking agent is used in an amount of less than 0.02 parts by weight, sufficient crosslinking may not be induced, resulting in poor wear resistance of a final molded foam. Meanwhile, if the organic peroxide crosslinking agent is used in an amount exceeding 4 parts by weight, excessive crosslinking may be induced, resulting in a remarkable increase in hardness.

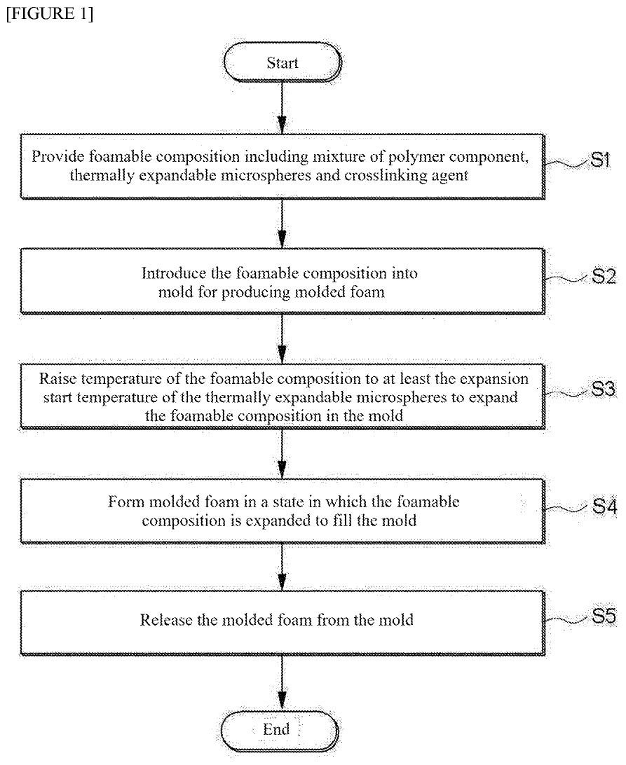

A further aspect of the present disclosure provides a method for producing a low specific gravity molded foam. FIG. 1 is a flowchart illustrating one embodiment of a method for producing a low specific gravity molded foam. Referring to FIG. 1, in step S1, a foamable composition is provided. The foamable composition includes a mixture of at least one polymer component selected from the group consisting of a peroxide-crosslinkable thermoplastic resin, a peroxide-crosslinkable rubber and a peroxide-crosslinkable thermoplastic elastomer, thermally expandable microspheres, and an organic peroxide crosslinking agent.

The foamable composition may be prepared by extrusion of the mixture with a suitable extruder, for example, a Buss kneader, a single screw extruder or a twin screw extruder. Various products can be manufactured by changing the processing conditions of the extruder, such as screw configuration, temperature setting, screw rotation speed, and extrusion output.

The mixture is introduced through a hopper of the extruder, transferred by a screw, and melted/mixed in a cylinder of the extruder. The cylinder is heated to such a temperature that the molten mixture is suitably flowable. It is preferred that the temperature of the cylinder is controlled between a temperature equal to or higher than the melting point of the polymer and a temperature equal to or lower than the Tₛₜₐᵣₜ of the thermally expandable microspheres. An excessively high temperature of the cylinder leads to excessive expansion of the thermally expandable microspheres, with the result that pellets obtained by extrusion are foamed, failing to achieve the intended purpose. The temperature of the cylinder is typically from 80 to 120° C. and may vary depending on the kind of the polymer. The screw rotation speed and the extrusion output can be appropriately controlled depending on the specific gravity and shape of the foamed extrudate. The processing conditions may be varied as needed.

As a result of the extrusion, the polymer component can be homogenized with the thermally expandable microspheres. The extrusion and cutting allow the foamable composition to have appropriate dimensions for subsequent processing in a mold. The extruded foamable composition may be in the form of pellets, rods or sheets. The foamable composition is preferably extruded into pellets that can be used to produce molded foams of various shapes. The dimensions of the pellets obtained by the extrusion can be determined depending on the specification and shape of the extruder die. The smallest one of the dimensions (diameter, thickness, and length) of the pellets may be in the range of 0.1 to 10 mm, preferably 1 to 5 mm. Within this range, the pellets adhere together well during molding and a foaming efficiency of the pellets may be excellent.

The extruded foamable composition may remain unfoamed or may be only slightly foamed. The density of the extrudate is 0.70 g/cm³ or more, which is preferred for ease of subsequent foaming in a mold. For example, the density of the extrudate may be 0.80 to 1.00 g/cm³. If the extrudate has a specific gravity lower than the lower limit defined above, the thermal conductivity of the extrudate is low, resulting in insufficient foaming or requiring a long time for sufficient foaming during subsequent molding.

The expansion start temperature of the thermally expandable microspheres is preferably higher than the extrusion temperature such that the mixture of the polymer and the thermally expandable microspheres remains unfoamed during extrusion. For slight prefoaming, the expansion start temperature of the thermally expandable microspheres may be lower by 5° C. or less than the extrusion temperature, if needed.

The expansion start temperature of the thermally expandable microspheres may be about 130 to about 220° C., for example, about 140 to about 200° C. The maximum expansion temperature of the thermally expandable microspheres may be about 150 to about 280° C., for example, about 170 to about 270° C. The expansion start temperature and the maximum expansion temperature can be appropriately selected according to the intended applications.

The thermally expandable microspheres may be expanded about 10- to about 100-fold, for example, about 30- to about 60-fold, relative to their initial volume at the maximum expansion temperature. When the composition of the present disclosure including the thermally expandable microspheres is heated, the thermally expandable microspheres are expanded and the resulting molded product includes the expanded thermally expandable microspheres. The volume of the thermally expandable microspheres in the molded product may be about 10 to about 50 times, for example, about 20 to about 40 times, larger than that before expansion.

The expanded thermally expandable microspheres are ultralight hollow microspheres, contributing to a reduction in the weight of a final product. In addition, the inherent high elasticity of the expanded thermally expandable microspheres can maintain and enhance the mechanical strength of a final product. Unlike general blowing agents, the thermally expandable microspheres form microscopic closed cells having a uniform size in a product after expansion, resulting in an improvement in the surface characteristics of a final product. The elasticity of the closed cells can also contribute to the prevention of shrinkage of a final product.

In step S2, the foamable composition is introduced into a mold for producing a molded foam. The foamable composition is preferably introduced in an amount to fill 50% or less, for example, 10 to 50%, of the volume of the mold. When the amount of the foamable composition used for molding is within the range defined above, a molded foam having a specific gravity as low as 0.5 or less, for example, 0.1 to 0.5, can be obtained, and a shape corresponding to the shape of the mold can be produced. The specific gravity of 0.5 or less is suitable for low specific gravity applications. If more than 50% of the volume of the mold is filled with the foamable composition, the specific gravity of a final molded foam exceeds 0.5, deteriorating the practicality of the molded foam.

The foamable composition introduced into the mold may remain unfoamed or may be only slightly foamed. The specific gravity of the only slightly foamed foamable composition may be 0.7 to 0.9. The foamable composition starting from unfoamed particles or only slightly foamed particles may be rapidly expanded during foaming processing in the mold due to its good thermal conductivity. If the specific gravity of the composition is lower than the lower limit defined above, the composition conducts heat less efficiently, resulting in insufficient foaming. In this case, the expanded product does not fill the mold and is thus likely to be defective.

In step S3, the temperature of the foamable composition is raised to at least the expansion start temperature (Tₛₜₐᵣₜ) of the thermally expandable microspheres to expand the foamable composition in the mold. The temperature of the foamable composition can be raised by directly or indirectly heating the mold with a heat source. For example, the temperature of the mold may be sufficiently raised by heating with electricity as a heat source.

The mold may be heated to a temperature higher than 140° C. but lower than 230° C., for example, a temperature between 150 and 210° C., preferably a temperature between 160 and 190° C. The heating temperature may vary depending on the kinds of the raw materials and the specific gravity of the foamable composition. If the temperature of the mold is less than the lower limit defined above, sufficient foaming cannot be achieved. Meanwhile, if the temperature of the mold exceeds the upper limit defined above, there is a risk that a final molded foam may deform, discolor or shrink.

In one embodiment, it is preferable to keep the inside of the mold in a vacuum state during expansion of the foamable composition. When the mold is evacuated to a vacuum, the expansion of the thermally expandable microspheres is promoted and facilitated by the vacuum once initiated. The vacuum can increase the expansion magnification of the thermally expandable microspheres. As a consequence, a well-foamed low specific gravity expansion product can be obtained without using a large amount of the thermally expandable microspheres to fill the mold. For example, the amount of the thermally expandable microspheres may be reduced by at least 10% when the mold is evacuated compared to when the mold is not evacuated.

A vacuum press as a pressurization device of a molding machine can be used to maintain the vacuum in the mold. A vacuum is created between heating plates of the press and the mold is located between the heating plates. When a general press is used as the pressurization device, a vacuum channel is formed in the vicinity of the mold cavity and a connector of a vacuum pump is connected to an outlet of the vacuum channel.

In step S4, a molded foam is formed in a state in which the foamable composition is expanded to fill the mold. In this step, the molding temperature is maintained in a state in which the mold is substantially completely filled with the foamable composition to complete the molded foam, such that the volume ratio of the mold to the molded foam is 1:1 to 1:1.1. The molding can be performed for 5 to 40 minutes, for example, while controlling the temperature of the mold and the degree of vacuum depending on the size and thickness of the final product. Since the thermal conduction efficiency may vary depending on the molding temperature and the specific gravity of the extrudate, these conditions can be controlled to shorten the molding time regardless of the shape of the product. The molding time may vary depending on the size and thickness of the final product but is preferably about 10 minutes when productivity is taken into account. In this process, it is preferable to make sufficient crosslinking so that a molded foam product having excellent durability can be achieved.

In step S5, the molded foam is released from the mold.

The molded foam undergoes no shrinkage even after demolding because crosslinking occurs in a state in which the foamable composition is substantially completely expanded in the mold.

Another aspect of the present disclosure provides a molded foam having a specific gravity of 0.5 or less produced by the method described above. The molded foam of the present disclosure has good dimensional stability and is applicable to low specific gravity applications because it undergoes no shrinkage.

The composition and the method of the present disclosure have the following advantages. First, the composition and the method of the present disclosure enable the production of a molded foam that undergoes no shrinkage, is unlikely to be defective, has good wear resistance and slip resistance, and is not hydrolyzed. Second, a small amount of the thermally expandable microspheres can be greatly expanded in the mold that can be evacuated to a vacuum. Third, the foamable composition starting from unexpanded particles or only slightly expanded particles has good thermal conductivity. Due to its good thermal conductivity, the foamable composition is rapidly expanded. Therefore, the use of the foamable composition is advantageous in terms of energy efficiency. Fourth, the mold temperature can be raised to a sufficient level, achieving high adhesive strength between the expanded pellets. Therefore, high strength of the molded foam is ensured and the risk of defects during production can be reduced.

The method of the present disclosure enables the production of a low specific gravity molded foam with good dimensional stability and durability compared to conventional methods for producing molded foams including mixing a blowing agent and thermally expandable microspheres with PVC or a thermoplastic rubber, expanding the mixture in a cylinder of an injection molding machine, injection molding the expanded mixture in a mold at room temperature, cooling the injection molded product, and demolding the final product. The molded foam produced by the method of the present disclosure has a low specific gravity of 0.5 or less.

The present disclosure will be more specifically explained with reference to the following examples. However, these examples are provided for ease of explanation and are not intended to limit the spirit of the present disclosure as defined in the accompanying claims.

### EXAMPLES

1) Raw Materials for Molded Foams

The following raw materials were used to produce molded foams of Examples 1-8 and Comparative Examples 1-12.

i) Polymer Components

EVA-1: Elvax 550 (Dupont, VA 15%, DSC melting point 89° C., MI (190° C., 2.16 kg) 8.0)

LDPE-1: LDPE 303 (Hanhwa Chem), specific gravity 0.919, MI (190° C., 2.16 kg) 6.0, DSC melting point 106° C.)

HDPE-1: M690 (Korea Petrochemical Ind. Co., Ltd., specific gravity 0.965, MI (190° C., 2.16 kg) 12.0, DSC melting point 135° C.)

BR-1: BR 01 (Kumho, cis 96%, ML 1+4 (100° C.) 45)

EPDM-1: KEP 210 (Kumho, ML 1+4 (125° C.) 25, ethylene 65%, ENB 5.7%)

ii) Thermally Expandable Microspheres

TEMS-1: Expancel 930 DU 120 (Akzo Nobel, Tₛₜₐᵣₜ 127° C., Tₘₐₓ 196° C.)

TEMS-2: Expancel 980 DU 120 (Akzo Nobel, Tₛₜₐᵣₜ 165° C., Tₘₐₓ 225° C.)

iii) Blowing Agent

Blowing Agent-1: DX-74 (Dongjin Semichem, azodicarbonamide, decomposition temperature 155° C.)

iv) Organic Peroxide Crosslinking Agents

Peroxide-1: Dicumyl peroxide (1 minute half-life temperature 175° C.)

Peroxide-2: Luperox 231 (Arkema, 1 minute half-life temperature 145° C.)

2) Production of Molded Foams

The polymer components, the thermally expandable microspheres, the blowing agent, and the organic peroxide crosslinking agents were mixed in kneaders. The blending ratios of the raw materials are shown in Tables 1 and 2. The figures given in the tables represent parts by weight of the components. Each of the mixtures was extruded with an extruder (L/D=36/1) at the predetermined temperature and underwater cut into 3-mm diameter pellets. An emulsion of 5% zinc stearate was used instead of water for the underwater cutting. The pellets were loaded into a mold (100 mm×200 mm×20 mm (volume 400 cc)). The amounts of the pellets loaded into the mold are shown in Tables 1 and 2. The pellets were molded while controlling the temperature of the mold and the degree of vacuum. After heating for 10 min while controlling the temperature of the mold and the degree of vacuum, the resulting product was released from the mold.

TABLE 1

| | Comparative | Comparative | Comparative | Comparative | | | | Comparative | | Comparative |
|---|---|---|---|---|---|---|---|---|---|---|
| | Example 1 | Example 2 | Example 3 | Example 4 | Example 1 | Example 2 | Example 3 | Example 5 | Example 4 | Example 6 |
| EVA-1 | 100 | | | | 100 | 100 | 100 | 100 | | |
| LDPE-1 | | 100 | | | | | | | 100 | |
| HDPE-1 | | | | | | | | | | 100 |
| BR-1 | | | 100 | | | | | | | |
| EPDM-1 | | | | 100 | | | | | | |
| TEMS-1 | | | | | 5.0 | 5.0 | | | 5.0 | 5.0 |
| TEMS-2 | | | | | | | 5.0 | 5.0 | | |
| Blowing | 5.0 | 5.0 | 5.0 | 5.0 | | | | | | |
| agent-1 | | | | | | | | | | |
| Peroxide-1 | 1.0 | 1.0 | 1.0 | 1.0 | 1.0 | | 1.0 | | 1.0 | 1.0 |
| Peroxide-2 | | | | | | 1.0 | | 1.0 | | |
| Extrusion | 100 | 120 | 100 | 100 | 100 | 100 | 100 | 100 | 120 | 145 |
| temp. (° C.) | | | | | | | | | | |
| Specific | 0.91 | 0.89 | 0.88 | 0.84 | 0.92 | 0.92 | 0.92 | 0.92 | 0.90 | (0.30) |
| gravity of | | | | | | | | | | |
| pellets | | | | | | | | | | |
| Amount | 100 | 100 | 100 | 100 | 100 | 100 | 100 | 100 | 100 | 100 |
| loaded into | | | | | | | | | | |
| mold (g) | | | | | | | | | | |
| Mold temp. | 160 | 160 | 160 | 160 | 160 | 160 | 180 | 180 | 160 | 160 |
| (° C.) | | | | | | | | | | |
| Crosslinking | 20 | 20 | 20 | 20 | 20 | 20 | 20 | 20 | 20 | 20 |
| time (min) | | | | | | | | | | |
| Evacuated? | Y | Y | Y | Y | N | N | N | N | N | N |
| (Yes/No) | | | | | | | | | | |
| Foamed state | (unfoamed) | (unfoamed) | (unfoamed) | (unfoamed) | Foamed | Foamed | Foamed | (substantially | Foamed | (slowly |
| | | | | | | | | unfoamed) | | foamed) |
| Filling of | (not filled) | (not filled) | (not filled) | (not filled) | Filled | Filled | Filled | (not filled) | Filled | (not filled) |
| expanded | | | | | | | | | | |
| product in | | | | | | | | | | |
| mold | | | | | | | | | | |
| Specific | (0.89) | (0.88) | (0.86) | (0.83) | 0.25 | 0.25 | 0.25 | (0.85) | 0.25 | 0.29 |
| gravity of | | | | | | | | | | |
| molded foam | | | | | | | | | | |
| Possible/ | (impos- | (impos- | (impos- | (impos- | Possible | Possible | Possible | (impos- | (impos- | Possible |
| impossible to | sible) | sible) | sible) | sible) | | | | sible) | sible) | |
| produce low | | | | | | | | | | |
| specific | | | | | | | | | | |
| gravity | | | | | | | | | | |
| molded foam? | | | | | | | | | | |

TABLE 2

| | Comparative | | Comparative | Comparative | | Comparative | | Comparative | Comparative |
|---|---|---|---|---|---|---|---|---|---|
| | Example 7 | Example 5 | Example 8 | Example 9 | Example 6 | Example 10 | Example 7 | Example 11 | Example 12 |
| EVA-1 | | | | 50 | 50 | 50 | 50 | | |
| LDPE-1 | | | | | | | | | |
| HDPE-1 | 100 | 100 | 100 | | | | | | |
| BR-1 | | | | 50 | 50 | | | | |
| EPDM-1 | | | | | | 50 | 50 | 100 | 100 |
| TEMS-1 | 5.0 | | | 5.0 | 5.0 | 5.0 | 5.0 | 5.0 | 5.0 |
| TEMS-2 | | 5.0 | 5.0 | | | | 5.0 | 5.0 | |
| Blowing | | | | | | | | | |
| agent-1 | | | | | | | | | |
| Peroxide-1 | 1.0 | 1.0 | | 1.0 | 1.0 | 1.0 | 1.0 | 1.0 | 1.0 |
| Peroxide-2 | | | 1.0 | | | | | | |
| Extrusion | 145 | 145 | 145 | 100 | 100 | 100 | 100 | 100 | 100 |
| temp. (° C.) | | | | | | | | | |
| Specific | (0.30) | 0.95 | 0.95 | 0.90 | 0.90 | 0.87 | 0.87 | 0.89 | 0.86 |
| gravity of | | | | | | | | | |
| pellets | | | | | | | | | |
| Amount | 100 | 100 | 100 | 100 | 190 | 100 | 190 | 200 | 280 |
| loaded into | | | | | | | | | |
| mold (g) | | | | | | | | | |
| Mold temp. | 160 | 180 | 180 | 160 | 160 | 160 | 160 | 160 | 160 |
| (° C.) | | | | | | | | | |
| Crosslinking | (40) | 20 | 20 | 20 | 20 | 20 | 20 | 20 | |
| time (min) | | | | | | | | | |
| Evacuated? | N | N | N | N | N | N | N | N | N |
| (Yes/No) | | | | | | | | | |
| Foamed state | Foamed | Foamed | (substantially | (slightly | Foamed | (slightly | Foamed | (slightly | Foamed |
| | | | unfoamed) | foamed) | | foamed) | | foamed) | |
| Filling of | Filled | Filled | (not filled) | (not filled) | Filled | (not filled) | Filled | (not filled) | Filled |
| expanded | | | | | | | | | |
| product in | | | | | | | | | |
| mold | | | | | | | | | |
| Specific | 0.25 | 0.25 | (0.89) | (0.55) | 0.45 | 0.48 | 0.45 | (0.75) | (0.70) |
| gravity of | | | | | | | | | |
| molded foam | | | | | | | | | |
| Possible/ | (impos- | Possible | (impos- | (impos- | Possible | (impos- | Possible | (impos- | (impos- |
| impossible to | sible) | | sible) | sible) | | sible) | | sible) | sible) |
| produce low | | | | | | | | | |
| specific | | | | | | | | | |
| gravity | | | | | | | | | |
| molded foam? | | | | | | | | | |

The numbers and descriptions in the parentheses indicate unsuitable physical properties.
In Comparative Examples 5 and 8, early crosslinking suppressed the expansion of the thermally expandable microspheres. In Comparative Examples 6 and 7, the pellets were first foamed, and as a result, heat was slowly conducted to the inside of the pellets, leading to slow foaming. When the crosslinking time was greatly increased, further expansion of the thermally expandable microspheres and sufficient crosslinking were achieved.

1. A method for producing a low specific gravity molded foam, comprising: providing a foamable composition comprising a mixture of at least one polymer component selected from the group consisting of a peroxide-crosslinkable thermoplastic resin, a peroxide-crosslinkable rubber and a peroxide-crosslinkable thermoplastic elastomer, thermally expandable microspheres, and an organic peroxide crosslinking agent; introducing the foamable composition into a mold for producing a molded foam; raising the temperature of the foamable composition to at least the expansion start temperature (Tₛₜₐᵣₜ) of the thermally expandable microspheres to expand the foamable composition in the mold; forming a molded foam in a state in which the foamable composition is expanded to fill the mold; and releasing the molded foam from the mold.

2. The method according to claim 1, wherein the foamable composition is prepared by extrusion of the mixture.

3. The method according to claim 1, wherein the foamable composition is in the form of pellets, rods or sheets.

4. The method according to claim 1, wherein the foamable composition is introduced in an amount to fill 50% or less of the volume of the mold.

5. The method according to claim 1, wherein the foamable composition introduced into the mold remains unfoamed or is only slightly foamed and the specific gravity of the only slightly foamed foamable composition is 0.7 to 0.9.

6. The method according to claim 1, wherein the temperature of the foamable composition is raised by directly or indirectly heating the mold with a heat source.

7. The method according to claim 6, wherein the mold is heated to a temperature higher than 140° C. but lower than 230° C.

8. The method according to claim 1, wherein the expansion start temperature (Tₛₜₐᵣₜ) of the thermally expandable microspheres is equal to or lower than the 1 minute half-life temperature of the organic peroxide crosslinking agent.

9. The method according to claim 1, wherein the thermally expandable microspheres have shells composed of an acrylonitrile copolymer.

10. The method according to claim 1, wherein the inside of the mold is kept in a vacuum state during expansion of the foamable composition.

11. The method according to claim 1, wherein the molding temperature is maintained in a state in which the mold is substantially completely filled with the foamable composition to complete the molded foam, such that the volume ratio of the mold to the molded foam is 1:1 to 1:1.1.

12. The method according to claim 1, wherein the molded foam is demolded after crosslinking in a state in which the foamable composition is expanded to substantially completely fill the mold.

13. A molded foam having a specific gravity of 0.5 or less produced by the method according to claim 1.

14. A composition for a low specific gravity molded foam, comprising at least one polymer component selected from the group consisting of a peroxide-crosslinkable thermoplastic resin, a peroxide-crosslinkable rubber and a peroxide-crosslinkable thermoplastic elastomer, thermally expandable microspheres, and an organic peroxide crosslinking agent.

15. The composition according to claim 14, wherein the expansion start temperature (Tₛₜₐᵣₜ) of the thermally expandable microspheres is equal to or lower than the 1 minute half-life temperature of the organic peroxide crosslinking agent.

16. The composition according to claim 14, wherein the thermally expandable microspheres are present in an amount of 1 to 20 parts by weight, based on 100 parts by weight of the polymer component.

17. The composition according to claim 14, wherein the organic peroxide crosslinking agent is present in an amount of 0.02 to 4 parts by weight, based on 100 parts by weight of the polymer component.
